(19) United States
(12) Patent Application Publication
(10) Pub. No.: US 2012/0101772 A1
(43) Pub. Date: Apr. 26, 2012

(54) DEVICE FOR THE MAGNETIC MEASUREMENT OF THE ROTATION OF A MAGNETISED BALL AND METHOD FOR MEASURING THE ROTATION OF THE BALL

(75) Inventors: François Frassati, Voreppe (FR); Roland Blanpain, Entre-Deux-Guiers (FR)

(73) Assignee: Commissariat A L'Energie Atomique Et Aux Energies Alternatives, Paris (FR)

(21) Appl. No.: 13/257,498

(22) PCT Filed: Mar. 19, 2010
(86) PCT No.: PCT/FR2010/000232

§ 371 Date: Oct. 19, 2011

(30) Foreign Application Priority Data
Mar. 19, 2009 (FR) 09 01285

(51) Int. Cl. G06F 15/00; G01B 7/30

(52) U.S. Cl. 702/150; 324/207.22

(57) ABSTRACT

A device and method for measuring rotation, the device including at least one ball, each ball being magnetized or having a temporary magnetization so as to present a dipole magnetization. The ball is free in rotation in a receptacle of a frame, the device including detection means of a magnetic field created by said at least one ball, along at least three non-coplanar axes of different directions.

### BACKGROUND OF THE INVENTION

The invention relates to a measuring device comprising at least one ball.

It also covers a method for measuring rotation of the ball.

### STATE OF THE ART

Different methods exist for measuring rotation of a ball. A first solution, which is found for example in conventional ball-mouses, is to measure the rotation of the ball by contact by means of rollers arranged tangentially to the surface of the ball. The rotation of the rollers is then measured by different known methods such as optic measurement, electric measurement, etc.

A text written on a sheet of paper can be digitized by means of a scanner. After scanning, a file of image type is obtained. To avoid having to use a scanner, digital pens have been developed which themselves perform digital acquisition during writing on a sheet of paper. U.S. Pat. No. 6,479,768 thus describes a pen comprising a magnetic ball whose rotation is continually measured so as to digitally transcribe what a user writes or draws on a sheet of paper. The magnetic ball generates a resultant magnetic field that does not present an axis of symmetry. Thus, as illustrated in exploded view in FIG. 1, a magnetized ball 1 can be in the form of two half-balls 1a and 1b, a magnetized sheet 2 being inserted there-between when the two half-balls 1a and 1b are assembled to form magnetized ball 1. Another method for obtaining a magnetized ball that does not present an axial symmetry, described in this document, is illustrated in FIG. 2. Six magnetic bars 3 are then arranged, two by two, along three distinct axes 4a, 4b and 4c passing through the center C of the ball. Fabrication of such balls makes industrialization complex as it requires several steps that have to be performed in precise manner. Furthermore, according to the embodiment of FIG. 1, assembly of the two half-balls 1a, 1b has to be perfect so that the pen does not catch when writing, and such an assembly is costly and difficult to industrialize.

### OBJECT OF THE INVENTION

The object of the invention is to provide a device for measuring the rotation of a magnetized ball on a surface that can be easily industrialized.

This object is achieved by the appended claims and more particularly by the fact that each ball being magnetized so as to present a dipole magnetization and being free in rotation in a receptacle of a frame, the device comprises detection means of a magnetic field created by said at least one ball along at least three non-coplanar axes of different directions.

It is a further object of the invention to provide a method for measuring rotation of the ball comprising the following successive steps:
determining the three components of the magnetic field vector created by the ball in the mobile reference frame of at least one magnetometer forming the detection means of the magnetic field,
computing a magnetization vector in the reference frame of the magnetometer from the magnetic field vector,
computing a rotation vector of the ball from the data of the magnetization vector in the reference frame of the magnetometer with respect to a fixed reference frame representative of the plane on which the ball is rolling, considering that pivoting of the ball is zero,
computing the movement of the ball in the plane from the rotation vector of the ball.

### BRIEF DESCRIPTION OF THE DRAWINGS

Other advantages and features will become more clearly apparent from the following description of particular embodiments of the invention given for non-restrictive example purposes only and represented in the appended drawings, in which:

FIGS. 1 and 2 illustrate alternative embodiments of magnetized balls used in magnetic measurement devices of the prior art.

FIG. 3 illustrates a device according to the invention, in cross-section.

FIG. 4 illustrates the method for magnetizing ferromagnetic balls.

FIGS. 5 and 6 illustrate other embodiments of balls.

FIG. 7 illustrates a device according to the invention forming a surface sensor.

FIG. 8 illustrates use according to one embodiment of a device in the form of a digital pen, in cross-section.

FIG. 9 illustrates an analysis algorithm of rotation of the ball of a measuring device.

FIG. 10 illustrates a digital pen using a ball as illustrated in FIG. 6.

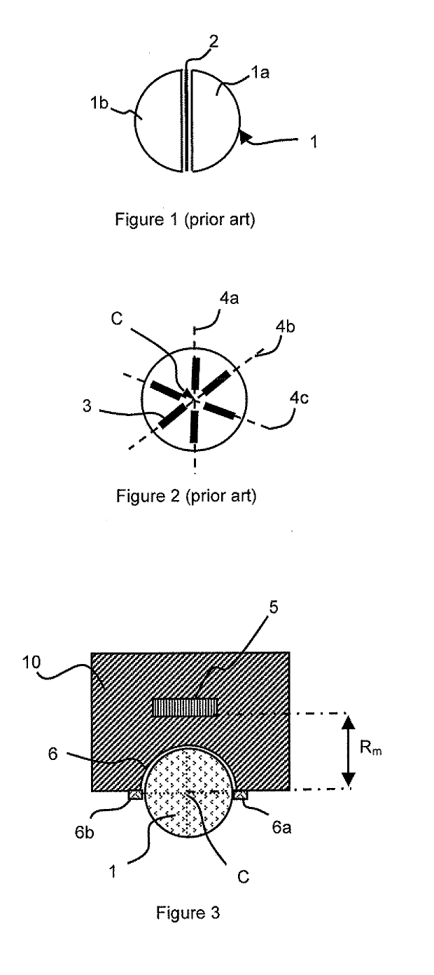

### DESCRIPTION OF PARTICULAR EMBODIMENTS

The device for measuring rotation, illustrated in FIG. 3, comprises at least one ball 1 free in rotation in a receptacle 6 of a frame 10. A ball is a sphere the outer surface of which is not deformable in normal use. What is meant by normal use is a constrained movement by rolling of the ball on a surface which may be flat or not.

Each ball 1 is magnetized or comprises temporary magnetization properties so as to present a dipole magnetization. In all cases, even if the ball is of temporary magnetization type, it comprises a dipole magnetization at a given time. The device is designed to measure the rotation of each ball 1 by studying the variation of the magnetic field generated by the latter. The variations of the magnetic field induced by ball 1 are measured by detection means 5 of a magnetic field along at least three non-coplanar axes and of different directions. The detection means of the magnetic field are preferably of magnetometer type 5 and are integrated in the measuring device. The detection means of the magnetic field are preferably placed at a fixed or quasi-fixed distance from the center C of ball 1.

What is meant by quasi-fixed is that the distance between the center C and the magnetic field detection means can vary slightly. The more precise it is sought to be, the smaller this variation has to be. Ball 1 in fact being free in rotation in receptacle 6, its center of gravity can have a small translation, necessary for the clearance allowing this free rotation. The translation will be considered as noise in measuring the magnetic field induced by ball 1, and will not have any incidence on the quality of the measurements if it remains very small.

Ball 1 can be secured in receptacle 6 by securing means 6a and 6b (FIG. 3) arranged at the level of receptacle 6. Receptacle 6 can also be shaped in suitable manner to hold ball 1 securely therein. As receptacle 6 only allows rotation of ball 1, it enables center C of ball 1 to be kept at a quasi-fixed distance Rₘ from magnetometer 5.

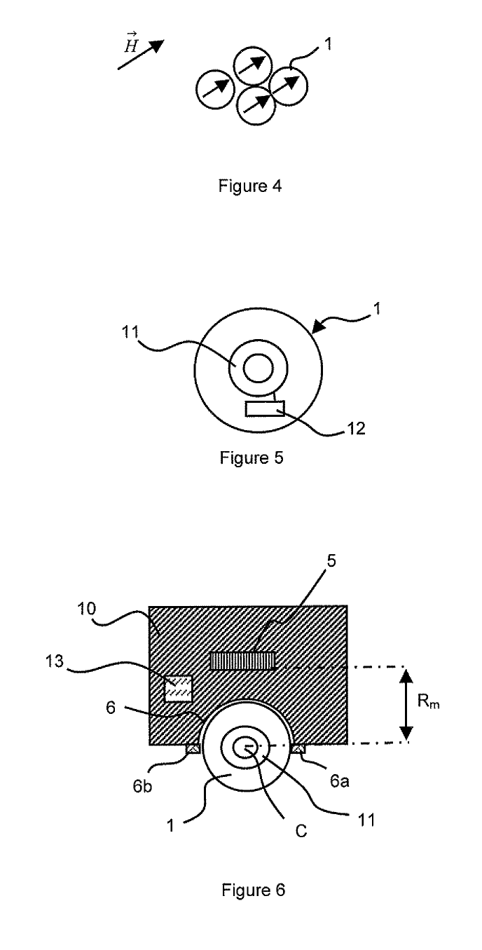

In one embodiment of the device, ball 1 with dipole magnetization presents a total axial symmetry that is very easy to achieve, with a uniform magnetization distribution. For this, as illustrated in FIG. 4, ball 1, presenting ferromagnetic characteristics necessary for magnetization, simply has to be immersed in a sufficiently strong polarizing external magnetic field \vec{H}. For example, the magnetic field \vec{H} necessary for magnetization of ball 1 is generated by the airgap of a magnet. This type of magnetization comprises undeniable advantages as far as industrialization is concerned. Depending on the size of the airgap, it is in fact possible to magnetize numerous balls 1 simultaneously as in FIG. 4.

The remanent magnetization of ball 1 has to be large compared with that of the local magnetic field if rotational movements of ball 1 are to being perceived. The local magnetic field corresponds to the resultant of the terrestrial magnetic field and of the magnetic fields present at the place where the measuring device is used.

Ball 1, presenting ferromagnetic properties, can be made from tungsten carbide containing cobalt, or any other ferromagnetic compound. Ball 1 can also be made from a composite or non-magnetic material in which a magnet or particles of ferromagnetic metal, for example Iron (Fe,) Cobalt (Co), Nickel (Ni) or alloys thereof, or ferromagnetic particles, have been incorporated when moulding.

Magnetization of ball 1 can be performed by any other means enabling it to be assimilated to a magnetic dipole, for example coils placed in ball 1 in which magnetization has been induced.

Thus, in a second embodiment of the device illustrated in FIG. 5, an inductive coil 11 can be placed in ball 1 and the coil be connected to a supply microbattery 12 providing a DC or AC power supply, microbattery 12 also being integrated in ball 1. This variant enables a constant or alternating magnetic field able to be assimilated to that of a magnetized ball to be generated in permanent manner, so long as battery 12 supplies coil 11. This magnetic field is dipole, as indicated in the foregoing.

In certain cases, ball 1 may be too small to integrate supply battery 12 and its electronic circuitry. The ball then comprises a coil 11 which can for example be in the form of a spiral turn, as illustrated in FIG. 6. For the coil to be able to induce a magnetic field, it has to be excited by means for generating 13 a magnetic field external to ball 1, said means for generating 13 being arranged for example in frame 10. The dipole obtained is not constant, and it becomes necessary to know the instantaneous intensity of the current in the coil to correct the values measured by magnetometer or magnetometers 5. This intensity can be determined by computing. In this case, the ball can be magnetized in temporarily dipole manner.

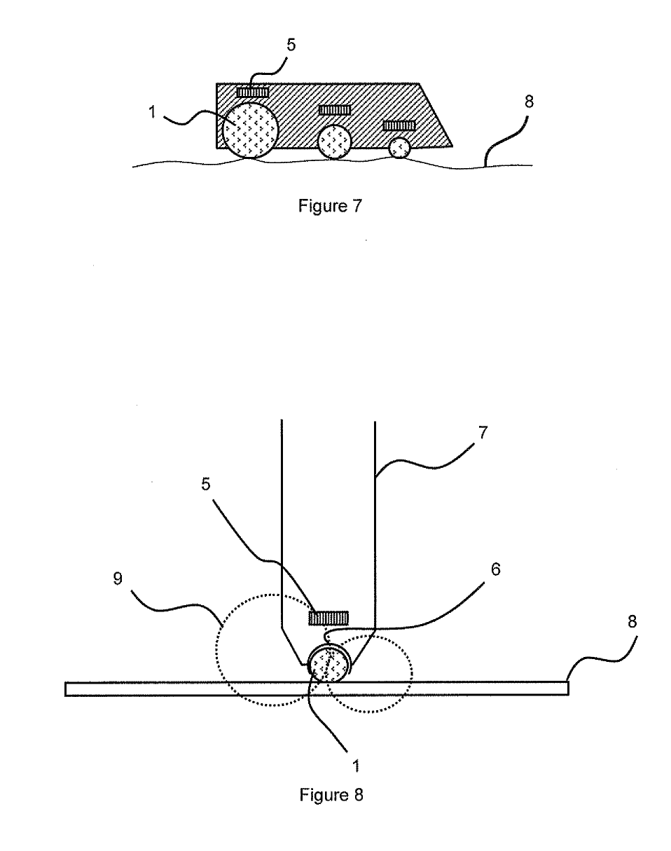

According to a particular embodiment illustrated in FIG. 7, the measuring device comprises three balls 1 of different diameters arranged in such a way as to roll tangentially to a plane 8 to form a surface sensor. The surface sensor enables the asperities of plane 8 on which balls move to be determined to establish precise mapping of this plane. In FIG. 7, each ball 1 is associated with a magnetometer 5. The use of several balls makes it possible to obtain a plurality of different measurements and to study the values of the incident magnetic fields to map the surface of plane 8.

In the case of the sensor, balls 1 can also be assimilated to AC dipoles, i.e. the magnetic field created by each ball 1 can be of magnetostatic type at a given frequency. This is obtained for example by coils placed in balls 1 and supplied by an AC voltage to create an alternating excitation field H. The excitation field then induces an alternating dipole magnetization in each ball 1. The rotational movements of one or more balls can thus be determined with magnetic field detection means by performing synchronous detections at each of the frequencies concerned. A single magnetometer can then be used to determine the movements of several balls.

The principle of alternating dipole can also be applied when the measuring device only comprises a single ball. Several distinct measuring devices will thus be able to operate in proximity to one another without any risk of disturbance.

The embodiment of FIG. 7 is not limited to three balls and can be adapted as required by the person skilled in the trade according to the required mapping precision. In general manner, a sensor comprises a plurality of balls of different diameters arranged so as to roll tangentially to one and the same plane.

As indicated in the foregoing, the magnetic field detection means can be magnetometers 5 enabling the magnetic field to be measured along at least three axes. Measurement along three axes provides the three components of the vector representative of the magnetic field generated by ball 1. These axes are preferably orthogonal to one another. A magnetometer 5 can be of Hall effect, fluxgate, giant magnetoresistance (GMR), anisotropic magnetoresistance (AMR), inductive type, etc. Certain of these magnetometers have a low consumption and enabling a device integrating the latter to be autonomous without becoming too bulky. It is also possible to use much more sensitive magnetometers, such as nuclear magnetic resonance or optical pumping magnetometers. The more sensitive magnetometer 5 is, the greater the extent to which the magnetic field of ball 1 can be reduced, or the farther this magnetometer 5 can be moved away from ball 1. Increasing the sensitivity of magnetometer 5 also enables weakly magnetic materials such as ferromagnetic or antiferromagnetic materials to be used for producing the ball.

The magnetic measuring device can be used for flowrate measurement, for measuring the speed of rotation of a wheel, of a vehicle or of a camshaft ball-bearing, etc. it can also be used in the field of handwriting recognition. Frame 10 of the measuring device can thus, as illustrated in FIG. 8, be in the form of an elongate body 7 to preferably form a digital pen comprising receptacle 6, at one of its ends, in which receptacle a ball 1 is housed. In other words, a single ball 1 is arranged at one end of said elongate body 7. Elongate body 7 further comprises means for detecting its tilt (not shown) to know the position of the pen when writing. The device then constitutes an autonomous digital ball-point pen. Association of ball 1, either magnetized or temporarily magnetized in dipole manner, and of a magnetometer 5 with at least three axes enables a text and/or drawings made on a fixed plane 8 to be digitized by moving the pen on this plane (by rolling ball 1). The data digitized by the pen (for example measurement of the magnetic field of the ball and the tilt of the pen) can be stored in an internal memory of the pen (not shown) and then transferred to a personal computer by connection means which may be hardwired or not. For example purposes, the connection means can be in the form of a Universal Serial Bus (USB), a WIFI transceiver, etc.

The measurements are in practice always made when ball 1 is in contact with a plane 8 or a surface and rolls without sliding on this plane or this surface. Ball 1 thus being in rotation, the probability of the latter rotating around the axis of symmetry of its magnetization is low. Simple dipole magnetization of the ball is therefore sufficient for use as a sensor or digital pen.

When the pen is used, as illustrated in FIG. 8, magnetized bail 1 rolls on a fixed plane 8. Magnetic field lines 9, created by ball 1, form loops in the space, closing on the magnetization axis (axis passing through the two poles). Rotation of ball 1 modifies the position of the field lines with respect to elongate body 7. The resulting magnetic field is measured and then analysed to determine the movement performed by ball 1 on plane 8. Analysis enables what the user has written and/or drawn to be extrapolated.

In general manner, the method for measuring rotation of the ball of any device as described in the foregoing can comprise a step of determining the three components of the magnetic field vector created by ball 1 in the moving reference frame of at least one magnetometer forming the magnetic field detection means. It is then possible to compute a magnetization vector in the reference frame of the magnetometer from the magnetic field vector. Rotation of ball 1 can then be determined by computing a rotation vector of ball 1 from the magnetization vector data in the reference frame of the magnetometer with respect to a fixed reference frame representative of a plane or a surface on which ball 1 is rolling, considering that pivoting of ball 1 is zero. What is meant by pivoting is the fact that the ball rotates only around its own axis. The plane can for example be a sheet of paper on which a user writes and/or draws. Finally, movement of the ball in the plane is computed from the rotation vector of ball 1.

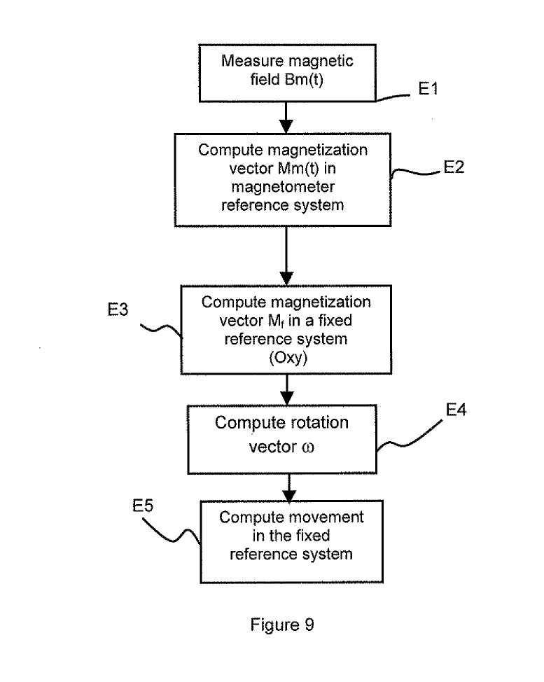

A first particular computation algorithm enabling the movements of the ball to be translated into letters and/or drawings is illustrated in FIG. 9. In a first measuring step E1 of the magnetic field of the ball, the magnetometer records the three components of the magnetic field vector \vec{B}ₘ(t) created by the ball in the moving reference frame of the magnetometer. A magnetization vector \vec{M}ₘ(t) in the reference frame of the magnetometer is then computed, in step E2, from the equation \vec{M}ₘ(t)=K·\vec{B}ₘ(t) in which K is an unknown constant matrix. Matrix K is given by the equation:

$$K = \frac{{μ}_{0}}{4 π {R}_{m}^{3}} ( \frac{3 {rr}^{T}}{{R}_{m}^{2}} - Id )$$

in which μ₀ is the magnetic permeability constant of a vacuum,
r is the vector representative of the coordinates of the center of the ball in the reference frame of the magnetometer,
Id is the identity matrix,
and Rₘ is the distance separating the center of the ball from the magnetometer.

A magnetization vector \vec{M}_{f} (step E3) is then determined in a fixed reference frame, for example the sheet of paper or the plane on which the ball is rolling. The orientation of the magnetometer with respect to the fixed reference frame is known in the form of a reference change matrix N(t), and the magnetization vector \vec{M}_{f} in the fixed reference frame can be written in the form of equation \vec{M}_{f}(t)=N(t). \vec{M}ₘ(t). Reference change matrix N(t) can be constant if the device is a surface sensor moving tangentially to a plane, or be determined by orientation measuring means such as accelerometers, spirit levels, etc., if the device is a digital pen whose tilt can change during use. Furthermore, in step E3, the derivatives of the magnetization with time in the fixed reference frame are computed. From the data of step E3 (\vec{M}_{f}(t) and derivatives with time), rotation vector \vec{ω} of the ball with respect to the fixed reference frame is computed in a step E4. For example purposes, in the case where pivoting of the ball is zero (ω_{z}=0), i.e. when the rotation vector of the ball is parallel to a plane Oxy corresponding to the surface on which the ball is rolling, rotation \vec{ω} of the ball with respect to the fixed reference frame is deduced by inverting the following equation:

$$\frac{d ( {\vec{M}}_{f} ( t ) )}{d t} = \vec{ω} ⋀ {\vec{M}}_{f} ( t )$$

(where ̂ is the vector product)
i.e.:

$${ω}_{x} = - \frac{\frac{d }{d t} ( {\vec{M}}_{fy} ( t ) )}{{\vec{M}}_{fz} ( t )}$$

$${ω}_{y} = - \frac{\frac{d }{d t} ( {\vec{M}}_{fx} ( t ) )}{{\vec{M}}_{fz} ( t )}$$

$${ω}_{z} = 0$$

From the results of step E4 of computation of the rotation vector of ball 1, movement of ball 1 on plane 8 can be computed. Indeed, if ball 1 rolls without sliding, the magnetic field is then modified and the point of contact of the ball on the plane, being referenced by cartesian coordinates (x, y), is obtained by:

dx=R_{b}·ω_{y}dt

dy=−R_{b}·ωₓdt

where dx and dy designate elementary movements along the axes x and y, and R_{b} designates the radius of the ball,
ωₓ and ω_{y} represent the rotation components along the axes x and y, and dt the measurement time step.

Such a pen or sensor, associated with the algorithm described above, enables the rotation of ball 1 to be measured without any contact other than with the sheet of paper or plane 8 used, thereby avoiding any parasitic measurement due to friction of the ball on its scroll-type measuring means as in the prior art. This algorithm functions provided the assumptions of non-sliding and non-pivoting are verified, which is the case when the ball or balls move by rolling on a plane.

In the case of the sensor, either the balls forming the latter have to be moved away from one another to prevent a first ball from disturbing the magnetometer of a second ball, or suitable filtering of the signals has to be performed. For example purposes, taking R_{b1} to be the radius of the first ball and R_{b2} the radius of the second ball, if the sensor moves at a speed Vₚ, the first ball produces a magnetic signal rotating at the speed Vₚ/R_{b1} and the second ball at the speed Vₚ/R_{b2}.

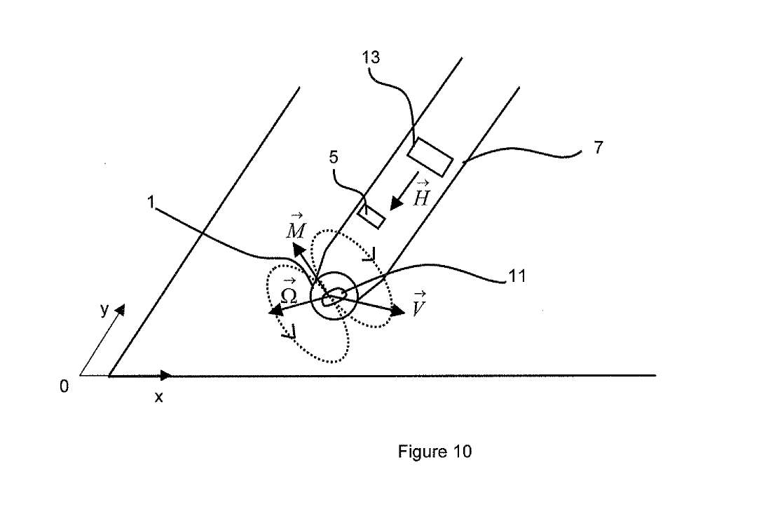

According to an embodiment using an inductive coil 11 placed in ball 1 and not being provided with an associated microbattery 12 to generate a constant magnetic field, frame 10 comprises means for generating 13 an excitation field represented in FIG. 10 by the vector \vec{H} and creating a magnetization vector \vec{M} induced in the coil turn. Vector \vec{H} is known and vector \vec{M} is measured at each time t. In fact as the ball rotates in the magnetic excitation field \vec{H}, the coil becomes the seat of an induced current which in turn produces an induced magnetization \vec{M}generating a magnetic field \vec{B} measurable by a magnetometer 5.

Vector v of FIG. 10 is a representation equivalent to the vector of movement of the ball during a time dt.

As in the case of a ball with permanent magnetization, measurement of magnetic field \vec{B} due to magnetization of the ball suffices to find the magnetization by the equation:

\vec{M}(t)=K·\vec{B}(t)

On the other hand, unlike permanent magnetization of the ball, the magnetization intensity is not constant and depends on the variation of the magnetic flux received by the coil, for example a turn, contained in the ball. This can be translated by the following equation:

\vec{M}(t)=I(t)·\vec{S}(t)

where I is the current flowing in the coil turn at time t,
\vec{S} is the surface vector of the coil turn at time t.

Surface vector \vec{S} corresponds to a vector perpendicular to the coil turn and with a norm equal to the surface of the coil turn. The induced magnetization \vec{M} is therefore always collinear to vector \vec{S}.

It is possible to determine I(t) using Lenz's law and noting Rₛ the resistance of the coil and φ the magnetic flux through the coil. We thus obtain:

$$I ( t ) = - \frac{1}{{R}_{s}} \frac{d ( Φ ( t ) )}{d t}$$

$$i . e . I ( t ) = - \frac{1}{{R}_{s}} \frac{d ( \vec{H} ( t ) \cdot \vec{S} ( t ) )}{d t}$$

By replacing \vec{S}(t) by \vec{M}(t)/I(t), the equation of progression of I(t) as a function of \vec{M}(t) is obtained:

$$I ( t ) = - \frac{1}{{R}_{s}} \frac{d ( \vec{H} ( t ) \cdot \vec{M} ( t ) / I ( t ) )}{d t}$$

and by developing the latter equation, we obtain:

$$( \vec{H} ( t ) \cdot \vec{M} ( t ) ) \frac{d I ( t )}{d t} = \frac{d ( \vec{H} ( t ) \cdot \vec{M} ( t ) )}{d t} \cdot I + {R}_{s} {I ( t )}^{3}$$

The inducing field \vec{H} and magnetization \vec{M} induced in the coil by \vec{H} being respectively known and measured, the differential equation simply has to be solved in I. This is a Bernoulli equation the solving methods of which are well known.

Magnetic excitation \vec{H} can be constant or variable in time. A variable excitation in time can be a sinusoidal excitation. In both cases (constant or variable excitation), the magnetometers have to be calibrated by measuring signal \vec{H} without making ball 1 rotate and the latter be subtracted from the measurements when ball 1 rotates.

Thus, knowing I(t) and \vec{M}(t), and orientation \vec{S}(t) of the coil turn by \vec{M}(t)=I(t)·\vec{S}(t), rotation \vec{Ω} of the ball can be deduced therefrom by the following rotation equation:

$$\frac{d}{d t} \vec{S} ( t ) = \vec{Ω} ⋀ \vec{S} ( t )$$

The latter equation is the same as that of the progression of the permanent magnetization as defined in the foregoing

$$( \frac{d ( {\vec{M}}_{f} ( t ) )}{d t} = \vec{ω} ⋀ {\vec{M}}_{f} ( t ) ) .$$

Therefore, knowing I(t), the previous algorithm can be applied in the same way.

In other words, if the ball has a temporary dipole magnetization, the magnetization vector in the reference frame of the magnetometer can be determined as in the first algorithm (step E2). This magnetization vector \vec{M}ₘ(t) in the reference frame of the magnetometer is also equal to I(t)·\vec{S}(t), where I is the current flowing in the coil at time t, \vec{S} the surface vector of the coil at time t, I(t) being known using Lenz's law. Rotation vector \vec{Ω} of the ball in a fixed reference frame representative of the plane in which the ball is moving is then deduced by inverting the equation

$$\frac{d}{d t} \vec{S} ( t ) = \vec{Ω} ⋀ \vec{S} ( t ) .$$

To perform suitable measurement at the level of matrix N(t), it is preferably necessary to know the tilt of the pen. This tilt can be determined by accelerometers as described in the foregoing. In certain cases, accelerometers are not necessarily sufficient, and it is then possible to improve measurement by using a terrestrial magnetometer, located for example in the frame, measuring the terrestrial magnetic field. However, the terrestrial magnetometer must not be disturbed by the magnetic field generated by ball 1. This constraint can be circumvented by using a ball 1 having a magnetic field 10 times the terrestrial magnetic field, and the distance separating ball 1 from the terrestrial magnetometer has to be 5 times the distance separating ball 1 from the detection means of the magnetic field of ball 1. Indeed, taking R_{b} as the radius of the ball, the induced field of the ball decreases by 1/R_{b}̂3 so that, if we place ourselves at a distance five times the distance separating the center of the ball from the magnetometer, a magnetic field 125 times weaker is obtained.

Measurements of the magnetic moment of the ball can be made at different times with a small step by a single magnetometer (tri-axial). It is then possible to measure the direction and intensity of rotation of the ball with respect to the fixed plane with great precision.

In known manner, using a processor of optic character recognition (OCR) type, the pen can perform recognition of the characters and generate a file compatible with known word processing software. This recognition can either be performed by the pen itself which generates a text file or, for reasons of limiting the consumption of the pen, by software installed on a personal computer not having problems of operation at low consumption, the data then being transmitted via suitable connection means.

1-16. (canceled)

17. A method for measuring a movement of a ball of a measuring device, comprising:
providing the measuring device comprising:
a frame with a receptacle,
the ball configured so as to present a dipole magnetization, and to freely rotate in the receptacle and to roll on a plane,
a magnetometer configured to detect three components of a magnetic field along least three non-coplanar axes of different directions,
determining three components of a magnetic field vector created by the ball by means of the magnetometer so as to obtain a first set of components of the magnetic field vector in a first mobile reference frame,
computing a magnetization vector in a second reference frame from the magnetic field vector, the second reference frame being arranged so that the magnetometer has a fixed location in the second reference frame,
computing a rotation vector of the ball from the magnetization vector in the second reference frame with respect to a third fixed reference frame representative of the plane on which the ball is rolling, considering that pivoting of the ball is zero,
computing the movement of the ball in the plane from the rotation vector.

18. The method according to claim 17, wherein the magnetization vector \vec{M}ₘ(t) in the second reference frame is computed by the equation \vec{M}ₘ(t)=K·\vec{B}ₘ(t) in which \vec{B}ₘ(t) is the magnetic field vector and K a constant matrix given by the equation
$$K = \frac{{μ}_{0}}{4 π {R}_{m}^{3}} ( \frac{3 {rr}^{T}}{{R}_{m}^{2}} - Id )$$
in which μ₀ is the magnetic permeability constant of a vacuum, r is the vector representative of the coordinates of a center of the ball in the second reference frame, Id the identity matrix, and Rₘ the distance separating the center of the ball from the magnetometer.

19. The method according to claim 18, wherein before computing the rotation vector of the ball, a magnetization vector \vec{M}_{f}(t) in the third fixed reference frame is computed by multiplying the magnetization vector \vec{M}ₘ(t) by a reference change matrix.

20. The method according to claim 19, wherein the rotation vector \vec{ω} of the ball with respect to the third fixed reference frame is computed by inverting the equation
$$\frac{d ( {\vec{M}}_{f} ( t ) )}{d t} = \vec{ω} ⋀ {\vec{M}}_{f} ( t ) .$$

21. The method according to claim 20, wherein computation of movement of the ball is established from contact points of the ball on the plane, said contact point being referenced by Cartesian coordinates x and y obtained by
dx=R_{b}·ω_{y}dt
dy=−R_{b}·ωₓdt
where dx and dy designate elementary movements along the axes x and y, ωₓ and ω_{y} represent the rotation components along the axes x and y, Rb designates the radius of the ball, and dt the measurement time step.

22. The method according to claim 18, wherein a coil is configured to generate a temporary dipole magnetization of the ball, the magnetization vector \vec{M}ₘ(t) in the second reference system is equal to I(t)·\vec{S}(t), where I is the current flowing in the coil at the time t, \vec{S} the surface vector of the coil at the time t, I(t) being known using Lenz's law.

23. The method according to claim 22, wherein the rotation vector \vec{Ω} of the ball with respect to the third fixed reference frame is deduced by inverting the equation
$$\frac{d}{d t} \vec{S} ( t ) = \vec{Ω} ⋀ \vec{S} ( t ) .$$

24. A measuring device comprising at least one ball, each ball being magnetized so as to present a dipole magnetization and being free in rotation in a receptacle of a frame, a detector of a magnetic field created by said at least one ball, along at least three non-coplanar axes of different directions.

25. The device according to claim 24, wherein the ball is made from tungsten carbide containing cobalt.

26. The device according to claim 24, wherein the ball is made from a non-magnetic material containing particles of ferromagnetic metal.

27. The device according to claim 24, wherein the ball comprises a coil and a microbattery connected to said coil so as to generate a magnetic field.

28. The device according to claim 24, wherein the ball comprises a coil, and the frame is provided with a generator configured to generate a magnetic field exciting said coil.

29. The device according to claim 24, comprising a plurality of balls of different diameters arranged such as to roll tangentially to a plane.

30. The device according to claim 24, wherein the frame forms an elongate body provided with means for detecting a tilt of the elongate body, a single ball being arranged at one end of said elongate body.

31. The device according to claim 30, comprising a terrestrial magnetometer measuring the terrestrial magnetic field.

32. The device according to claim 31, wherein the ball is configured to present a magnetic field ten times higher than the terrestrial magnetic field and wherein the distance separating the ball from the terrestrial magnetometer is equal to five times the distance separating the ball from the detector of the magnetic field of the ball.
